(19) United States
(12) Patent Application Publication
(10) Pub. No.: US 2011/0248676 A1
(43) Pub. Date: Oct. 13, 2011

(54) BATTERY PACK

(76) Inventor: Dae-Won Kim, Yongin-si (KR)

(21) Appl. No.: 12/960,381

(22) Filed: Dec. 3, 2010

(30) Foreign Application Priority Data
Apr. 12, 2010 (KR) 10-2010-0033327

(51) Int. Cl. H02J 7/00; H02H 3/00

(52) U.S. Cl. 320/118; 361/88

(57) ABSTRACT

An improved battery pack is disclosed. The battery pack includes: a plurality of battery cells; a protection circuit module for controlling charging and discharging of the plurality of battery cells; and a plurality of connection members for applying voltages output from the plurality of battery cells to the protection circuit module, at least one of the connection members having a damping resistive component.

### CROSS-REFERENCE TO RELATED APPLICATION

This application claims priority to and the benefit of Korean Patent Application No. 10-2010-0033327, filed on Apr. 12, 2010, in the Korean Intellectual Property Office, the disclosure of which is incorporated herein in its entirety by reference.

### BACKGROUND

1. Field

Aspects of one or more embodiments according to the present invention relate to a battery pack.

2. Description of Related Art

As portable electronic devices, for example, mobile phones, digital cameras, and laptop computers, are being widely used, development on batteries as a power source for driving the portable electronic devices is being actively conducted.

A battery pack includes one or more battery cells and a protection circuit that controls charging and discharging of the battery cells, and batteries may be classified into lithium ion (Li-ion) batteries and nickel-cadmium (Ni—Cd) batteries, etc. The battery cell is a rechargeable battery (e.g., a secondary battery) and may be recharged for a number of times.

### SUMMARY

Aspects of one or more embodiments according to the present invention are directed toward a battery pack that may prevent fire from occurring due to a short between wires outputting voltages (e.g., intermediate voltages) from battery cells.

Additional aspects will be set forth in part in the description which follows and, in part, will be apparent from the description, or may be learned by practice of the presented embodiments.

According to one or more embodiments of the present invention, a battery pack includes: a plurality of battery cells; a protection circuit module for controlling charging and discharging of the plurality of battery cells; and a plurality of connection members for applying voltages output from the plurality of battery cells to the protection circuit module, at least one of the connection members having a damping resistive component.

At least one of the connection members may include a first wire having the damping resistive component and a second wire formed of a material having a specific resistance value less than that of the first wire.

The connection members may be coupled between the protection circuit module and the battery cells, the first wire may be coupled to and adjacent a terminal of the battery cells, and the second wire may be coupled to and adjacent an input terminal of the protection circuit module.

At least one of the connection members may be a single electric wire having a damping resistance value.

The connection members may be outside of the protection circuit module.

The voltages output from the plurality of battery cells may have different magnitudes, and a number of connection members may correspond to a number of voltages output from the plurality of battery cells.

According to one embodiment, a battery pack includes a plurality of battery cells; a protection circuit module; and a plurality of voltage sensing wires coupled between the battery cells and the protection circuit module, the voltage sensing wires being for supplying voltages of the battery cells to the protection circuit module. At least one of the voltage sensing wires is external to the protection circuit module and has a resistive component for preventing a short circuit between the protection circuit module and the battery cells.

The at least one of the sensing wires may include a first portion and a second portion, the first portion and the second portion having different specific resistance values. One of the first portion or the second portion may include the resistive component.

### BRIEF DESCRIPTION OF THE DRAWINGS

These and/or other aspects of the present invention will become apparent and more readily appreciated from the following description of the embodiments, taken in conjunction with the accompanying drawings of which:

FIG. 1 is a perspective view of a battery pack according to an embodiment of the present invention;

FIG. 2 is a circuit diagram schematically illustrating a protection circuit module included in the battery pack of FIG. 1;

FIG. 3 is a circuit diagram schematically illustrating connection members included in the battery pack of FIG. 1;

FIG. 4 is a perspective view of a battery pack according to another embodiment of the present invention; and

FIG. 5 is a circuit diagram schematically illustrating connection members included in the battery pack of FIG. 4.

### DETAILED DESCRIPTION

Hereinafter, one or more embodiments of the present invention will be described in more detail with reference to the accompanying drawings. Here, when a first element is described as being coupled or connected to a second element, the first element may be directly coupled to the second element or indirectly coupled to the second element via one or more third elements. In the drawings, like reference numerals denote like elements. Accordingly, detailed description will not be repeated.

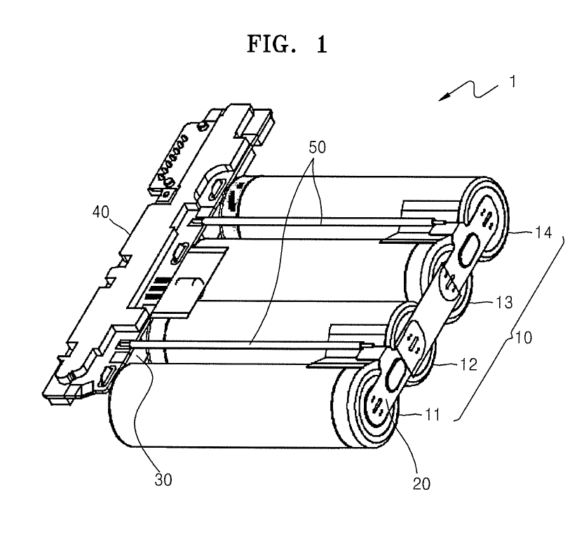

FIG. 1 illustrates a battery pack 1 according to an embodiment of the present invention.

Referring to FIG. 1, the battery pack 1 includes a battery 10, a first combining member 20, a second combining member 30, a protection circuit module 40, and connection members 50.

The battery 10 may include one or more battery cells (e.g., battery cells 11, 12, 13, and 14) and may be charged or discharged through a charge terminal connected to an external device. The battery cells 11 through 14 each include an electrode assembly, a can, and a cap assembly, wherein the electrode assembly includes a positive electrode plate, a negative electrode plate, and a separator. The can accommodates the electrode assembly and has an opening at a top end thereof, and the cap assembly is positioned on the opening of the can to seal the can. These battery cells 11 through 14 may be secondary batteries that may be rechargeable. In the embodiment of FIG. 1, the battery 10 includes the four battery cells 11 through 14. However, the present invention is not limited thereto, and different number of battery cells may be included in the battery pack 1 according to a desired capacity of the battery pack 1.

The first combining member 20 and the second combining member 30 connects the battery cells 11 through 14 in series or in parallel and prevents or reduces movement of the battery cells 11 through 14. The structures of the first combining member 20 and the second combining member 30 may vary according to the connection (e.g., in series or in parallel) of the battery cells 11 through 14. In the embodiment of FIG. 1, the four battery cells 11 through 14 are connected to each other in series, and accordingly, the first combining member 20 may include conductive members that respectively electrically connect a positive electrode of the battery cell 11 with a negative electrode of the battery cell 12 and a positive electrode of the battery cell 13 with a negative electrode of the battery cell 14. Also, the second combining member 30 may include a conductive member that electrically connects a positive electrode of the battery cell 12 with a negative electrode of the battery cell 13.

The protection circuit module 40 controls charging and discharging of the battery 10. The protection circuit module 40 may include input terminals for receiving an output voltage of the battery 10 and at least one intermediate voltage (e.g., a voltage at a connection between two battery cells) output from the battery 10. Also, the protection circuit module 40 may include a charging terminal that may connect to a charger or a load.

The connection members 50 (e.g., voltage sensing wires), which are outside of the protection circuit module 40, apply intermediate voltage outputs from the battery 10 to the protection circuit module 40, and include a damping resistive component. According to the connection of the battery cells 11 through 14, the battery 10 may output various intermediate voltages. The number of connection members 50 may correspond to the number of intermediate voltages to be output from the battery 10, and the connection members 50 may apply each intermediate voltage to the corresponding input terminal of the protection circuit module 40. In one embodiment of the present invention, the four battery cells 11 through 14 are connected to each other in series, and accordingly, three intermediate voltages having different magnitudes may be output. Accordingly, the battery pack 1 according to one embodiment may include three connection members 50.

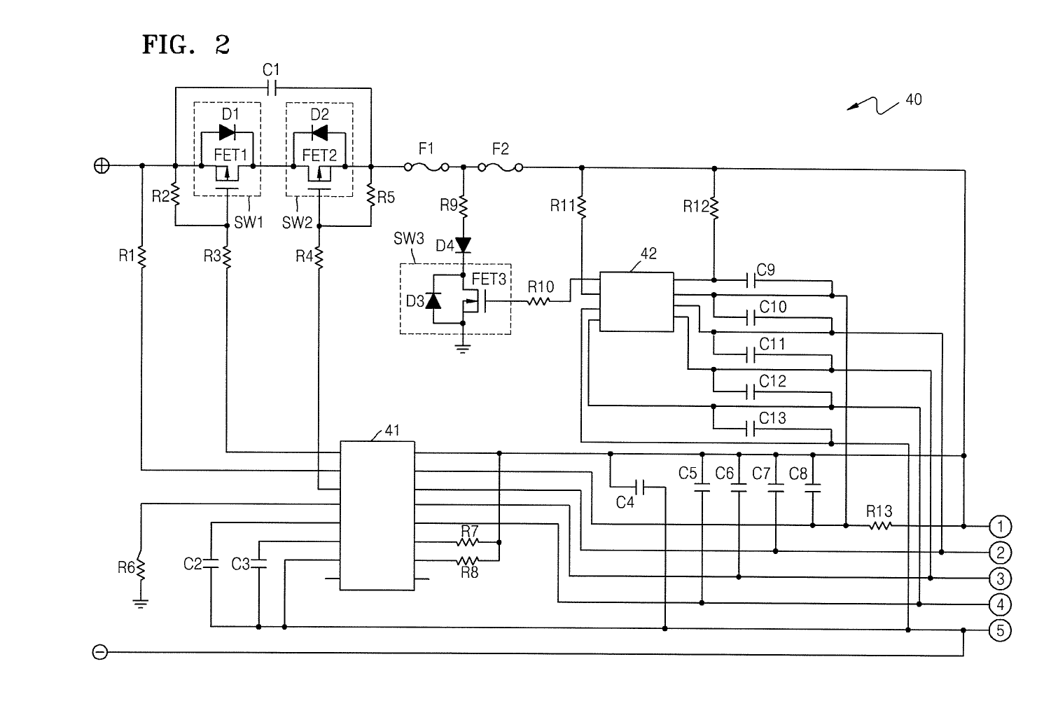

FIG. 2 is a circuit diagram schematically illustrating the protection circuit module 40 included in the battery pack of FIG. 1 according to an embodiment of the present invention. The protection circuit module 40 is described below in more detail with reference to FIG. 2.

The protection circuit module 40 according to an embodiment may include a plurality of input and output terminals, first, second, and third switches SW1, SW2, and SW3, a plurality of fuses F1 and F2, and first and second logic circuits 41 and 42.

A positive terminal (+) and a negative terminal (−) of the protection circuit module 40 are connected to an external device or a charger.

The first switch SW1 and the second switch SW2 may include field effect transistors (FETs) and parasitic diodes D. In FIG. 2, the first switch SW1 includes a transistor FET1 and a parasitic diode D1, and the second switch SW2 includes a transistor FET2 and a parasitic diode D2. A connecting direction between source and drain of the FET1 of the first switch SW1 is opposite to that of the FET2 of the second switch SW2. Accordingly, the FET1 of the first switch SW1 is connected to restrict a current flowing to the positive terminal from the battery 10 and to the battery 10 from the negative terminal, whereas the FET2 of the second switch SW2 is connected to restrict a current flowing to the battery 10 from the positive terminal and to the negative terminal from the battery 10. Here, the FET1 and the FET2 are switching devices. However, the present invention is not limited thereto, and the FET1 and the FET2 may be electronic devices that perform other kinds of switching functions. Also, the parasitic diodes D1 and D2 respectively included in the first switch SW1 and the second switch SW2 allow a current to flow in a direction opposite to the direction by which a current flow is restricted.

When the battery 10 is unstable, such as when an excessive current flows, the plurality of fuses F1 and F2 causes circuits to become open circuits to block the current flow.

When an abnormal state occurs in the battery pack 1, such as when an excessive current flows in a high current path, the third switch SW3 is switched on to cut (e.g., melt) the fuses F1 and F2.

The first logic circuit 41 and the second logic circuit 42 may sense over-charging, over-discharging, and a temperature of the battery 10 or an excessive current flowing in the battery 10. In order to control charging and discharging of the battery 10, the first logic circuit 41 may control on/off states of the first switch SW1 and the second switch SW2. In order to block a high current path and stop operation of the battery pack 1, the second logic circuit 42 may control on/off states of the third switch SW3.

The voltages output from the battery 10 are applied to the plurality of input terminals 1 through 5 of the protection circuit 40. In FIG. 2, output voltages of the battery 10 are respectively applied to input terminals 1 and 5, and a plurality of intermediate voltages output from the battery 10 are respectively applied to input terminals 2 through 4.

Also, the protection circuit module 40 according to the embodiment of FIG. 2 may include a plurality of resistors R1 through R13, a plurality of capacitors C1 through C13, and a diode D4.

The first logic circuit 41 and the second logic circuit 42 may receive the plurality of intermediate voltages from the battery 10 for cell balancing of the battery cells 11 through 14 (shown in FIG. 1). Here, the protection circuit module 40 according to one embodiment does not include a device having a resistive component between the input terminals 2 through 4, to which the intermediate voltages of the battery 10 are applied, and input terminals of the first logic circuit 41 and the second logic circuit 42, to which the intermediate voltages are input.

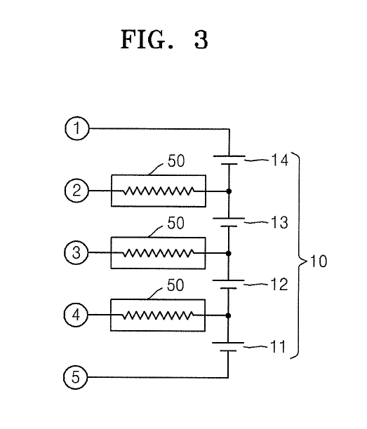

FIG. 3 is a circuit diagram schematically illustrating the connection members 50 included in the battery pack 1 of FIG. 1.

Referring to FIG. 3, the output voltages of the battery 10 are respectively applied to the input terminals 1 and 5 of the protection circuit module 40. Also, the intermediate voltages are generated from portions (e.g., connection points) by which the battery cells 11 through 14 are connected to each other and are respectively applied to the input terminals 2 through 4 of the protection circuit module 40. Here, the intermediate voltages are transmitted to the protection circuit module 40 from the battery cells 11 through 14 by the connection members 50. The connection members 50 each have a damping resistive component for preventing a fire when a short is generated. The connection members 50 may be formed of a material having a relatively high resistance value in order to behave as a damping resistive component. That is, the connection members 50 may each be a single electric wire formed of a material having a relatively high specific resistance value.

In general, when an intermediate voltage of a battery is applied to a logic circuit included in a protection circuit module, a damping resistive component is formed between an input terminal of the protection circuit module to which the intermediate voltage is applied and an input terminal of the logic circuit to which the intermediate voltage is input, to protect the circuit. The damping resistive component is formed to cope with a problem such as a short that may be easily generated in the protection circuit.

However, in the battery pack 1 according to the embodiment of FIG. 2, the damping resistive component in the protection circuit module 40 is removed, thereby simplifying an internal circuit of the protection circuit module 40. Also, the damping resistive component for protecting a circuit of the protection circuit module 40 is formed in the connection members 50. Accordingly, when a short occurs between the connection members 50, since the connection members 50 have resistive components, and thus a fire generation due to a short may be reduced or prevented.

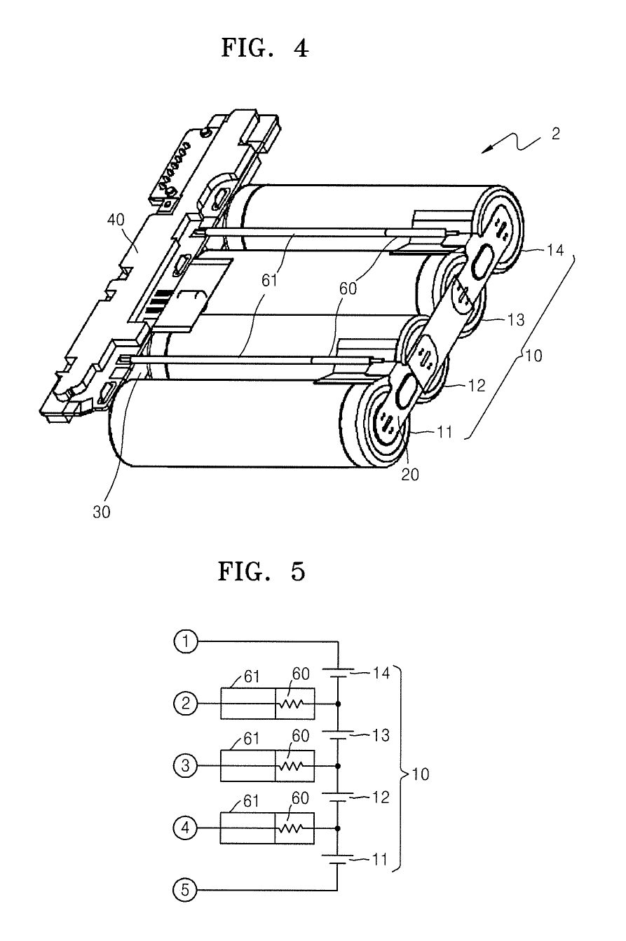

FIG. 4 illustrates a battery pack 2 according to another embodiment of the present invention. The battery pack 2 has a structure and function similar to those of the battery pack 1 of FIG. 1, and thus only differences therebetween are described.

Referring to FIG. 4, in the battery pack 2, an intermediate voltage output from the battery 10 is applied to the protection circuit module 40 by using first connection members 60 and second connection members 61.

The first connection members 60 may each be a device or a wire having a damping resistive component. Each of the first connection members 60 is connected to a corresponding terminal of the battery cells 11 through 14, for example, positive terminals (+) or negative terminals (−) thereof, and a corresponding one of the input terminals of the protection circuit module 40.

The second connection members 61 are each a wire having a specific resistance value less than that of each of the first connection members 60, e.g., a wire formed of a material having a relatively small internal resistance. The second connection members 61 are each connected to the protection circuit module 40 between the battery cells 11 through 14 and the input terminals of the protection circuit module 40.

FIG. 5 is a circuit diagram schematically illustrating the connection members 60 and 61 included in the battery pack 2 of FIG. 4.

As illustrated in FIG. 4, the first connection members 60 are each connected between the battery cells 11 through 14, and each of the first connection members 60 is connected to a corresponding one of the second connection members 61. Also, each of the second connection members 61 is connected to a corresponding one of the input terminals 2 through 4 of the protection circuit module 40 and applies an intermediate voltage to one of the input terminals 2 through 4.

As described above, in the battery pack 2 according to one embodiment, the damping resistive component in the protection circuit module 40 is removed, thereby simplifying an internal circuit of the protection circuit module 40. Also, the first connection members 60 are each formed to have the damping resistive component and are connected to be adjacent to the input terminals of the protection circuit 40, thereby reducing the likelihood of a fire occurring due to a short.

It should be understood that the exemplary embodiments of the present invention described therein should be considered in a descriptive sense only and not for purposes of limitation, but, on the contrary, it is intended to cover various modifications and equivalent arrangements included within the spirit and scope of the appended claims, and equivalents thereof. Descriptions of features or aspects within each embodiment should typically be considered as available for other similar features or aspects in other embodiments.

What is claimed is:

1. A battery pack comprising:
a plurality of battery cells;
a protection circuit module for controlling charging and discharging of the plurality of battery cells; and
a plurality of connection members for applying voltages output from the plurality of battery cells to the protection circuit module, at least one of the connection members having a damping resistive component.

2. The battery pack of claim 1, wherein at least one of the connection members comprises a first wire having the damping resistive component and a second wire formed of a material having a specific resistance value less than that of the first wire.

3. The battery pack of claim 2, wherein the connection members are coupled between the protection circuit module and the battery cells, the first wire is coupled and adjacent to a terminal of the battery cells, and the second wire is coupled and adjacent to an input terminal of the protection circuit module.

4. The battery pack of claim 1, wherein at least one of the connection members is a single electric wire having a damping resistance value.

5. The battery pack of claim 1, wherein the connection members are outside of the protection circuit module.

6. The battery pack of claim 1, wherein the voltages output from the plurality of battery cells have different magnitudes, and a number of the connection members corresponds to a number of the voltages output from the plurality of battery cells.

7. A battery pack comprising:
a plurality of battery cells;
a protection circuit module; and
a plurality of voltage sensing wires coupled between the battery cells and the protection circuit module, the voltage sensing wires for supplying voltages of the battery cells to the protection circuit module,
wherein at least one of the voltage sensing wires is external to the protection circuit module and has a resistive component for preventing a short circuit between the protection circuit module and the battery cells.

8. The battery pack of claim 7, wherein the at least one of the sensing wires comprises a first portion and a second portion, the first portion and the second portion having different specific resistance values.

9. The batter pack of claim 8, wherein one of the first portion or the second portion comprises the resistive component.
